(19) United States
(12) Patent Application Publication
(10) Pub. No.: US 2012/0300844 A1
(43) Pub. Date: Nov. 29, 2012

(54) CASCADED MOTION COMPENSATION

(75) Inventors: Zhan Ma, Plano, TX (US); Christopher A. Segall, Camas, WA (US)

(73) Assignee: SHARP LABORATORIES OF AMERICA, INC., Camas, WA (US)

(21) Appl. No.: 13/116,470

(22) Filed: May 26, 2011

(51) Int. Cl. H04N 7/26

(52) U.S. Cl. 375/240.16; 375/E07.027

(57) ABSTRACT

A video decoder decodes video from a bit-stream including a low resolution predictor that predicts pixel values based upon both a low resolution reference image and an interpolated high resolution reference image at positions different from the low resolution reference image using low resolution motion data. A high resolution predictor predicts pixel values using a non-interpolated high resolution reference image at positions different from the low resolution reference image using the low resolution motion data, wherein the non-interpolated high resolution reference image and the interpolated high resolution reference image are co-sited.

### CROSS-REFERENCE TO RELATED APPLICATIONS

None.

### BACKGROUND OF THE INVENTION

The present invention relates to a video system with power reduction.

Existing video coding standards, such as H.264/AVC, generally provide relatively high coding efficiency at the expense of increased computational complexity. The relatively high computational complexity has resulted in significant power consumption, which is especially problematic for low power devices such as cellular phones.

Power reduction is generally achieved by using two primary techniques. The first technique for power reduction is opportunistic, where a video coding system reduces its processing capability when operating on a sequence that is easy to decode. This reduction in processing capability may be achieved by frequency scaling, voltage scaling, on-chip data pre-fetching (caching), and/or a systematic idling strategy. In many cases the resulting decoder operation conforms to the standard. The second technique for power reduction is to discard frame or image data during the decoding process. This typically allows for more significant power savings but generally at the expense of visible degradation in the image quality. In addition, in many cases the resulting decoder operation does not conform to the standard.

### BRIEF DESCRIPTION OF THE SEVERAL VIEWS OF THE DRAWINGS

FIG. 1 illustrates a decoder.

FIG. 2 illustrates low resolution prediction.

FIGS. 3A and 3B illustrate a decoder and data flow for the decoder.

FIG. 4 illustrates a sampling structure of the frame buffer.

FIG. 5 illustrates integration of the frame buffer in the decoder.

FIG. 6 illustrates representative pixel values of two blocks.

FIG. 7 illustrates motion compensation.

FIG. 8 illustrates cascaded motion compensation.

FIG. 9 illustrates low and high resolution decomposition.

FIG. 10 illustrates intra prediction.

FIG. 11 illustrates low resolution intra prediction.

FIG. 12 illustrates bilinear interpolation for low resolution intra prediction.

FIG. 13 illustrates direct copy interpolation for low resolution intra prediction.

FIG. 14 illustrates directional pixel estimation for low resolution intra prediction.

FIG. 15 illustrates low and high resolution pixel interpolation.

### DETAILED DESCRIPTION OF PREFERRED EMBODIMENT

It is desirable to enable significant power savings typically associated with discarding frame data without visible degradation in the resulting image quality and standard non-conformance. Suitably implemented the system may be used with minimal impact on coding efficiency. In order to facilitate such power savings with minimal image derogation and loss of coding efficiency, the system should operate alternatively on low resolution data and high resolution data. The combination of low resolution data and high resolution data may result in full resolution data. Furthermore, the full resolution data that corresponds to the low resolution data is referred to as a low resolution grid location. Similarly, the full resolution data that corresponds to the high resolution data is referred to as a high resolution grid location. The use of low resolution data is particularly suitable when the display has a resolution lower than the resolution of the transmitted content.

Power is a factor when designing higher resolution decoders. One major contributor to power usage is memory bandwidth. Memory bandwidth traditionally increases with higher resolutions and frame rates, and it is often a significant bottleneck and cost factor in system design. A second major contributor to power usage is high pixel counts. High pixel counts are directly determined by the resolution of the image frame and increase the amount of pixel processing and computation. The amount of power required for each pixel operation is determined by the complexity of the decoding process. Historically, the decoding complexity has increased in each “improved” video coding standard.

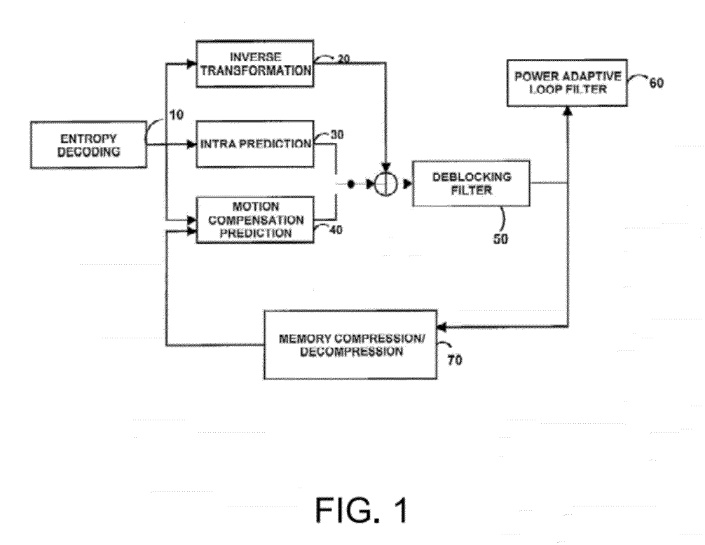

Referring to FIG. 1, the system may include an entropy decoding module 10, a transformation module (such as inverse transformation using a dequant IDCT) 20, an intra prediction module 30, a motion compensated prediction module 40, a deblocking module 50, an adaptive loop filter module 60, and a memory compression/decompression module associated with a frame buffer 70. The arrangement and selection of the different modules for the video system may be modified, as desired. The system, in one aspect, preferably reduces the power requirements of both memory bandwidth and high pixel counts of the frame buffer. The memory bandwidth is reduced by incorporating a frame buffer compression technique within a video codec design. The purpose of the frame buffer compression technique is to reduce the memory bandwidth (and power) required to access data in the reference picture buffer. Given that the reference picture buffer is itself a compressed version of the original image data, compressing the reference frames can be achieved without significant coding loss for many applications.

To address the high pixel counts, the video codec should support a low resolution processing mode without drift. This means that the decoder may switch between low-resolution and full-resolution operating points and be compliant with the standard. This may be accomplished by performing prediction of both the low-resolution and high-resolution data using the full-resolution prediction information but only the low-resolution data. Additionally, this may be improved using a de-blocking process that makes de-blocking decisions using only the low-resolution data. De-blocking is applied to the low-resolution data and, also if desired, the high-resolution data. The de-blocking of the low-resolution data does not depend on the high-resolution data. The low resolution deblocking and high resolution deblocking may be performed serially and/or in parallel. However, the de-blocking of the high resolution data may depend on the low-resolution data. In this manner the low resolution process is independent of the high resolution process, thus enabling a power savings mode, while the high resolution process may depend on the low resolution process, thus enabling greater image quality when desired.

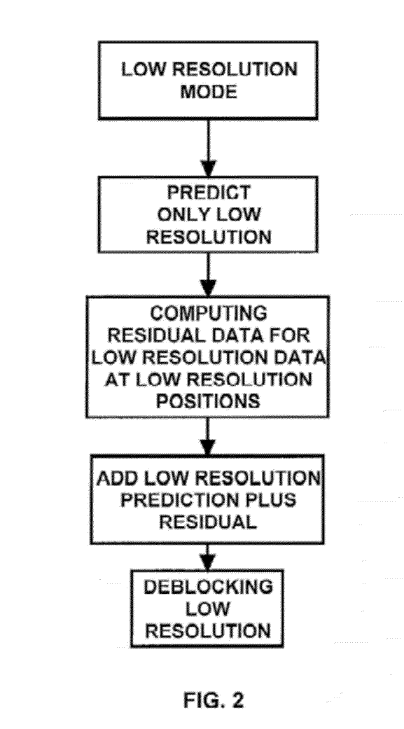

Referring to FIG. 2, when operating in the low-resolution mode, a decoder may exploit the properties of low-resolution prediction and modified de-blocking to significantly reduce the number of pixels to be processed. This may be accomplished by predicting only the low-resolution data. Then after predicting the low resolution data, computing the residual data for only the low-resolution data (i.e., pixel locations) and not the high resolution data (i.e., pixel locations). The residual data is typically transmitted in a bit-stream. The residual data computed for the low-resolution data has the same pixel values as the full resolution residual data at the low-resolution grid locations. The principal difference is that the residual data needs to only be calculated at the low-resolution grid locations. Following calculation of the residual, the low-resolution residual is added to the low-resolution prediction. The resulting signal is then de-blocked. Again, the de-blocking is preferably performed at only the low-resolution grid locations to reduce power consumption. Finally, the result may be stored in the reference picture frame buffer for future prediction. Optionally, the result may be processed with an adaptive loop filter. The adaptive loop filter may be related to the adaptive loop filter for the full resolution data, or it may be signaled independently, or it may be omitted.

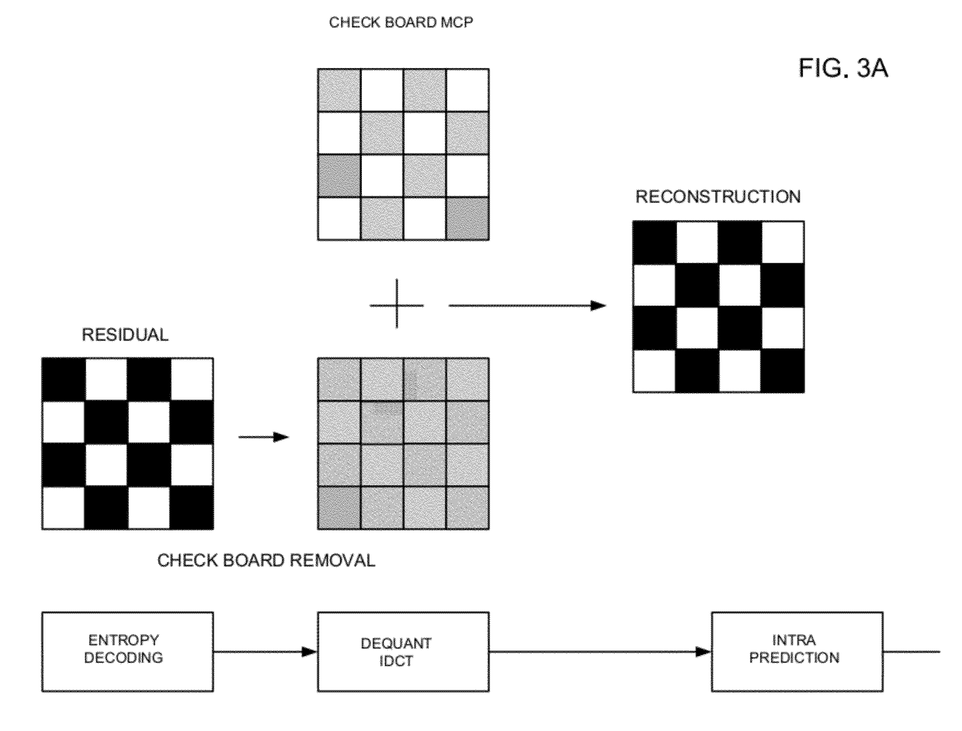

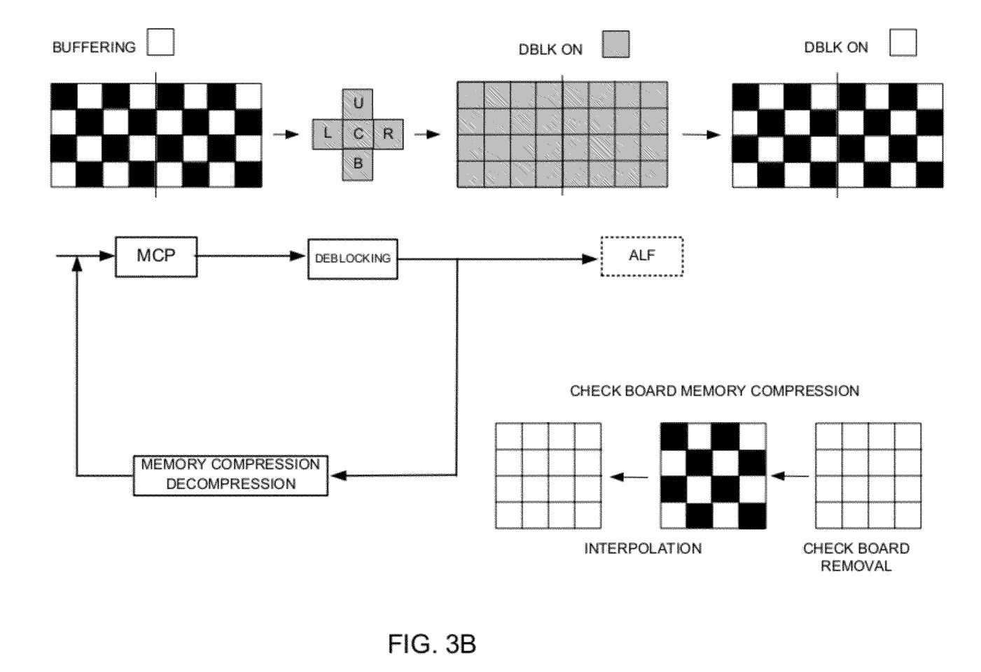

An exemplary depiction of the system operating in low-resolution mode is shown in FIGS. 3A and 3B. The system may likewise include a mode that operates in full resolution mode. As shown in FIGS. 3A and 3B, entropy decoding may be performed at full resolution, while the inverse transform (Dequant IDCT) and prediction (Intra Prediction; Motion Compensated Prediction (MCP)) are preferably performed at low resolution. The de-blocking is preferably performed in a cascade fashion so that the de-blocking of the low resolution data does not depend on the additional, high resolution data. Finally, a frame buffer that includes memory compression stores the low-resolution data used for future prediction.

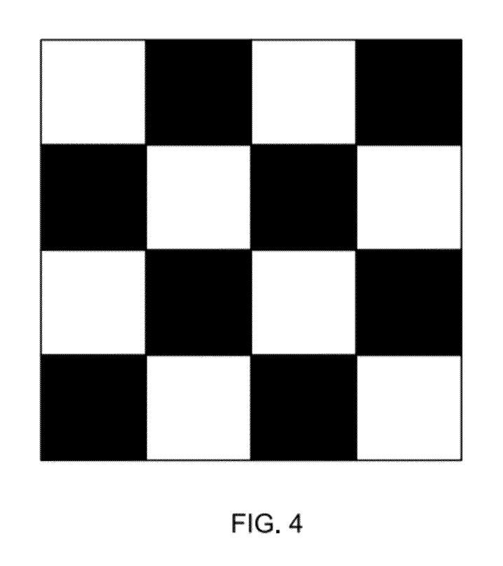

The frame buffer compression technique is preferably a component of the low resolution functionality. The frame buffer compression technique preferably divides the image pixel data into multiple sets, and that a first set of the pixel data does not depend on other sets. In one embodiment, the system employs a checker-board pattern as shown in FIG. 4. In FIG. 4, the shaded pixel locations belong to the first set and the un-shaded pixels belong to the second set. Other sampling structures may be used, as desired. For example, every other column of pixels may be assigned to the first set. Alternatively, every other row of pixels may be assigned to the first set. Similarly, every other column and row of pixels may be assigned to the first set. Any suitable partition into multiple sets of pixels may be used.

For memory compression/decompression the frame buffer compression technique preferably has the pixels in a second set of pixels be linearly predicted from pixels in the first set of pixels. The prediction may be pre-defined. Alternatively, it may be spatially varying or determined using any other suitable technique.

In one embodiment, the pixels in the first set of pixels are coded. This coding may use any suitable technique, such as for example, block truncation coding (BTC), such as described by Healy, D.; Mitchell, O., “Digital Video Bandwidth Compression Using Block Truncation Coding,” IEEE Transactions on Communications [legacy, pre-1988], vol. 29, no. 12 pp. 1809-1817, December 1981, absolute moment block truncation coding (AMBTC), such as described by Lema, M.; Mitchell, O., “Absolute Moment Block Truncation Coding and Its Application to Color Images,” IEEE Transactions on Communications [legacy, pre-1988], vol. 32, no. 10 pp. 1148-1157, October 1984, or scalar quantization. Similarly, the pixels in the second set of pixels may be coded and predicted using any suitable technique, such as for example being predicted using a linear process known to the frame buffer compression encoder and frame buffer compression decoder. Then the difference between the prediction and the pixel value may be computed. Finally, the difference may be compressed. In one embodiment, the system may use block truncation coding (BTC) to compress the first set of pixels. In another embodiment, the system may use absolute moment block truncation coding (AMBTC) to compress the first set of pixels. In another embodiment, the system may use quantization to compress the first set of pixels. In yet another embodiment, the system may use bi-linear interpolation to predict the pixel values in the second set of pixels. In a further embodiment, the system may use bi-cubic interpolation to predict the pixel values in the second set of pixels. In another embodiment, the system may use bi-linear interpolation to predict the pixel values in the second set of pixels and absolute moment block truncation coding (AMBTC) to compress the residual difference between the predicted pixel values in the second set and the pixel value in the second set.

A property of the frame buffer compression technique is that it is controlled with a flag to signal low resolution processing capability. In one configuration when this flag does not signal low resolution processing capability, then the frame buffer decoder produces output frames that contain the first set of pixel values (i.e. low resolution pixel data), possibly compressed, and the second set of pixel values (i.e. high resolution pixel data) that are predicted from the first set of pixel values and refined with optional residual data. In another configuration when this flag does signal low resolution processing capability, then the frame buffer decoder produces output frames that contain the first set of pixel values, possibly compressed, and the second set of pixel values that are predicted from the first set of pixel values but not refined with optional residual data. Accordingly, the flag indicates whether or not to use the optional residual data. The residual data may represent the differences between the predicted pixel values and the actual pixel values.

For the frame buffer compression encoder, when the flag does not signal low resolution processing capability, then the encoder stores the first set of pixel values, possibly in compressed form. Then, the encoder predicts the second set of pixel values from the first set of pixel values. In some embodiments, the encoder determines the residual difference between the prediction and actual pixel value and stores the residual difference, possibly in compressed form. In some embodiments, the encoder selects from multiple prediction mechanisms a preferred prediction mechanism for the second set pixels. The encoder then stores the selected prediction mechanism in the frame buffer. In one embodiment, the multiple prediction mechanisms consist of multiple linear filters and the encoder selects the prediction mechanism by computing the predicted pixel value for each linear filter and selecting the linear filter that computes a predicted pixel value that is closest to the pixel value. In one embodiment, the multiple prediction mechanisms consist of multiple linear filters and the encoder selects the prediction mechanism by computing the predicted pixel values for each linear filter for a block of pixel locations and selecting the linear filter that computes a block of predicted pixel value that are closest to the block of pixel values. A block of pixels is a set of pixels within an image. The determination of the block of predicted pixel values that are closest to the block of pixel values may be determined by selecting the block of predicted pixel values that result in the smallest sum of absolute differences between the block of predicted pixels values and block of pixels values. Alternatively, the sum of squared differences may be used to select the block. In other embodiments, the residual difference is compressed with block truncation coding (BTC). In one embodiment, the residual difference is compressed with the absolute moment block truncation coding (AMBTC). In one embodiment, the parameters used for the compression of the second set pixels are determined from the parameters used for the compression of the first set of pixels. In one embodiment, the first set of pixels and second set of pixels use AMBTC, and a first parameter used for the AMBTC method of the first set of pixels is related to a first parameter used for the AMBTC method for the second set of pixels. In one embodiment, said first parameter used for the second set of pixels is equal to said first parameter used for the first set of pixels and not stored. In another embodiment, said first parameter used for the second set of pixels is related to said first parameter used for the first set of pixels. In one embodiment, the relationship may be defined as a scale factor, and the scale factor stored in place of said first parameter used for the second set of pixels. In other embodiments, the relationship may be defined as an index into a look-up-table of scale factors, the index stored in place of said first parameter used for the second set of pixels. In other embodiments, the relationship may be pre-defined. In other embodiments, the encoder combines the selected prediction mechanism and residual difference determination step. By comparison, when the flag signals low resolution processing capability, then the encoder stores the first set of pixel values, possibly in compressed form. However, the encoder does not store residual information. In embodiments described above that determine a selected prediction mechanism, the encoder does not compute the selected prediction mechanism from the reconstructed data. Instead, any selected prediction mechanism is signaled from the encoder to the decoder.

The signaling of a flag enables low resolution decoding capability. The decoder is not required to decode a low resolution sequence even when the flag signals a low resolution decoding capability. Instead, it may decode either a full resolution or low resolution sequence. These sequences will have the same decoded pixel values for pixel locations on the low resolution grid. The sequences may or may not have the same decoded pixel values for pixel locations on the high resolution grid. The signaling the flag may be on a frame-by-frame basis, on a sequence-by-sequence basis, or any other basis.

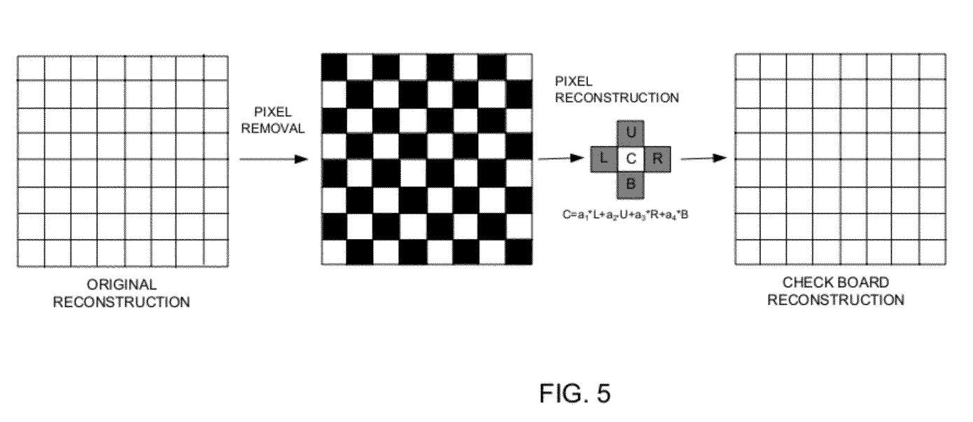

When the flag appears in the bit-stream, the decoder preferably performs the following steps:
(a) Disables the residual calculation in the frame buffer compression technique. This includes disabling the calculation of residual data during the loading of reference frames as well as disabling the calculation of residual data during the storage of reference frames, as illustrated in FIG. 5.
(b) Uses low resolution data for low resolution deblocking, as previously described. Uses an alternative deblocking operation for the high resolution grid locations, as previously described.
(c) Stores reference frames prior to applying the adaptive loop filter.

With these changes, the decoder may continue to operate in full resolution mode. Specifically, for future frames, it can retrieve the full resolution frame from the compressed reference buffer, perform motion compensation, residual addition, de-blocking, and loop filter. The result will be a full resolution frame. This frame can still contain frequency content that occupies the entire range of the full resolution pixel grid.

Alternatively though, the decoder may choose to operate only on the low-resolution data. This is possible due to the independence of the lower resolution grid locations on the higher resolution grid locations in the buffer compression structure. For motion estimation, the interpolation process is modified to exploit the fact that high resolution data are linearly related to the low-resolution data. Thus, the motion estimation process may be performed at low resolution with modified interpolation filters, such as a bilinear filter, a bicubic filter, or an edge directed filter. Similarly, for residual calculation, the system may exploit the fact that the low resolution data does not rely on the high resolution data in subsequent steps of the decoder. Thus, the system uses a reduced inverse transformation process that only computes the low resolution grid locations from the full resolution transform coefficients. Finally, the system employs a de-blocking filter that de-blocks the low-resolution data independent from the high-resolution data (the high-resolution data may be dependent on the low-resolution data). This is again due to the linear relationship between the high-resolution and lower-resolution data.

An existing deblocking filter in the JCT-VC Test Model under Consideration JCTVC-A119 is desired in the context of 8×8 block sizes. For luma deblocking filtering, the process begins by determining if a block boundary should be de-blocked. This is accomplished by computing the following

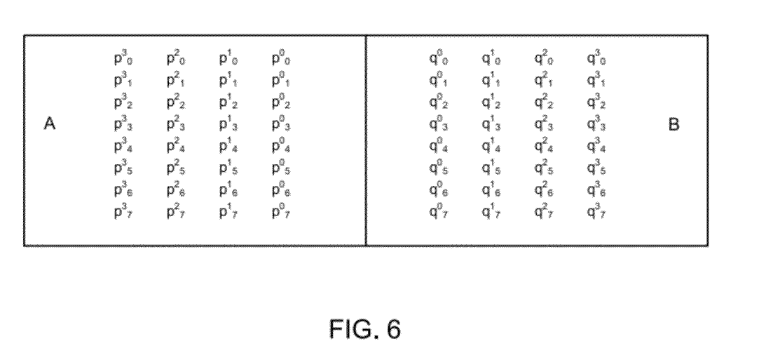

d=|p2₂−2*p1₂+p0₂|+|q2₂−2*q1₂+q0₂|+|p2₅−2*p1₅+p0₅|+|q2₅−2*q1₅+q0₅|,

where d is a threshold and piⱼ and qiⱼ are pixel values. The location of the pixel values are depicted in FIG. 6. In FIG. 6, two 4×4 coding units are shown. However, the pixel values may be determined from any block size by considering the location of the pixels relative to the block boundary.

Next, the value computed for d is compared to a threshold. If the value d is less than the threshold, the de-blocking filter is engaged. If the value d is greater than or equal to the threshold, then no filtering is applied and the de-blocked pixels have the same values as the input pixel values. Note that the threshold may be a function of a quantization parameter, and it may be described as beta(QP). The de-blocking decision is made independently for horizontal and vertical boundaries.

If the d value for a boundary results in a decision to de-block, then the process continues to determine the type of filter to apply. The de-blocking operation uses either strong or weak filter types. The choice of filtering strength is based on the previously computed d, beta(QP) and also additional local differences. This is computed for each line (row or column) of the de-blocked boundary. For example, for the first row of the pixel locations shown in FIG. 6, the calculation is computed as

StrongFilterFlag=((d<beta(QP)) && ((|p3ᵢ−p0ᵢ|+|q0ᵢ−q3ᵢ|)<(β>>3) && |p0ᵢ−q0ᵢ|<((5*t_{c}+1)>>1)).

where t_{c} is a threshold that is typically a function of the quantization parameter, QP.

For the case of luminance samples, if the previously described process results in the decision to de-block a boundary and subsequently to de-block a line (row or column) with a weak filter, then the filtering process may be described as follows. Here, this is described by the filtering process for the boundary between block A and block B in FIG. 6. The process is:

Δ=Clip(−t_{c},t_{c}, (13*(q0ᵢ−p0ᵢ)+4*(q1ᵢ−p1ᵢ)−5*(q2ᵢ−p2ᵢ)+16)>>5)) i=0,7

p0ᵢ=Clip₀₋₂₅₅(p0ᵢ+Δ) i=0,7

q0ᵢ=Clip₀₋₂₅₅(q0ᵢ+Δ) i=0,7

p1ᵢ=Clip₀₋₂₅₅(p1ᵢ+Δ/2) i=0,7

q1ᵢ=Clip₀₋₂₅₅(q1ᵢ+Δ/2) i=0,7

where Δ is an offset and Clip₀₋₂₅₅( ) is an operator the maps the input value to the range [0,255]. In alternative embodiments, the operator may map the input values to alternative ranges, such as [16,235], [0,1023] or other ranges.

For the case of luminance samples, if the previously described process results in the decision to de-block a boundary and subsequently to de-block a line (row or column) with a strong filter, then the filtering process may be described as follows. Here, this is described by the filtering process for the boundary between block A and block B in FIG. 6. The process is:

p0ᵢ=Clip₀₋₂₅₅((p2ᵢ+2*p1ᵢ+2*p0ᵢ+2*q0ᵢ+q1ᵢ+4)>>3); i=0,7

q0i=Clip₀₋₂₅₅((p1ᵢ+2*p0ᵢ+2*q0ᵢ+2*q1ᵢ+q2ᵢ+4)>>3); i=0,7

p1i=Clip₀₋₂₅₅((p2ᵢ+p1ᵢ+p0ᵢ+q0ᵢ+2)>>2); i=0,7

q1i=Clip₀₋₂₅₅((0ᵢ+q1ᵢ+q2ᵢ+2)>>2); i=0,7

p2i=Clip₀₋₂₅₅((2*p3ᵢ+3*p2ᵢ+p1ᵢ+p0ᵢ+q0ᵢ+4)>>3); i=0,7

q2i=Clip₀₋₂₅₅((p0ᵢ+q0ᵢ+q1ᵢ+3*q2ᵢ+2*q3ᵢ+4)>>3); i=0,7

where Clip₀₋₂₅₅( ) is an operator the maps the input value to the range [0,255]. In alternative embodiments, the operator may map the input values to alternative ranges, such as [16,235], [0,1023] or other ranges.

For the case of chrominance samples, if the previously described process results in the decision to de-block a boundary, then all lines (row or column) or the chroma component is processed with a weak filtering operation. Here, this is described by the filtering process for the boundary between block A and block B in FIG. 6, where the blocks are now assumed to contain chroma pixel values. The process is:

Δ=Clip(−t_{c},t_{c},((((q0ᵢ−p0ᵢ)<<2)+p1ᵢ−q1ᵢ+4)>>3)) i=0,7

p0ᵢ=Clip₀₋₂₅₅(p0ᵢ+Δ) i=0,7

q0ᵢ=Clip₀₋₂₅₅(q0ᵢ−Δ) i=0,7

where Δ is an offset and Clip₀₋₂₅₅( ) is an operator the maps the input value to the range [0,255]. In alternative embodiments, the operator may map the input values to alternative ranges, such as [16,235], [0,1023] or other ranges.

The pixel locations within an image frame may be partitioned into two or more sets. When a flag is signaled in the bit-stream, or communicated in any manner, the system enables the processing of the first set of pixel locations without the pixel values at the second set of pixel locations. An example of this partitioning is shown in FIG. 4. In FIG. 4, a block is divided into two sets of pixels. The first set corresponds to the shaded locations; the second set corresponds to the unshaded locations.

When this alternative mode is enabled, the system may modify the previous de-blocking operations as follows:

First in calculating if a boundary should be de-blocked, the system uses the previously described equations, or other suitable equations. However, for the pixel values corresponding to pixel locations that are not in the first set of pixels, the system may use pixel values that are derived from the first set of pixel locations. In one embodiment, the system derives the pixel values as a linear summation of neighboring pixel values located in the first set of pixels. In a second embodiment, the system uses bi-linear interpolation of the pixel values located in the first set of pixels. In a preferred embodiment, the system computes the linear average of the pixel value located in the first set of pixels that is above the current pixel location and the pixel value located in the first set of pixels that is below the current pixel location. Please note that the above description assumes that the system is operating on a vertical block boundary (and applying horizontal de-blocking). For the case that the system is operating on a horizontal block boundary (and applying vertical de-blocking), then the system computes the average of the pixel to the left and right of the current location. In an alternative embodiment, the system may restrict the average calculation to pixel values within the same block. For example, if the pixel value located above a current pixel is not in the same block but the pixel value located below the current pixel is in the same block, then the current pixel is set equal to the pixel value below the current pixel.

Second, in calculating if a boundary should use the strong or weak filter, the system may use the same approach as described above. Namely, the pixels values that do not correspond to the first set of pixels are derived from the first set of pixels. After computing the above decision, the system may use the decision for the processing of the first set of pixels. Decoders processing subsequent sets of pixels use the same decision to process the subsequent sets of pixels.

If the previously described process results in the decision to de-block a boundary and subsequently to de-block a line (row or column) with a weak filter, then the system may use the weak filtering process described above. However, when computing the value for Δ, the system does not use the pixel values that correspond to the set of pixels subsequent to the first set. Instead, the system may derive the pixel values as discussed above. By way of example, the value for Δ is then applied to the actual pixel values in the first set and the delta value is applied to the actual pixel values in the second set.

If the previously described process results in the decision to de-block a boundary and subsequently to de-block a line (row or column) with a strong filter, then the system may do the following:

In one embodiment, the system may use the equations for the luma strong filter described above. However, for the pixel values not located in the first set of pixel locations, the system may derive the pixel values from the first set of pixel locations as described above. The system then store the results of the filter process for the first set of pixel locations. Subsequently, for decoders generating the subsequent pixel locations as output, the system uses the equations for the luma strong filter described above with the previously computed strong filtered results for the first pixel locations and the reconstructed (not filtered) results for the subsequent pixel locations. The system then applies the filter at the subsequent pixel locations only. The output are filtered first pixel locations corresponding to the first filter operation and filtered subsequent pixel locations corresponding to the additional filter passes.

To summarize, as previously described, the system takes the first pixel values and interpolates the missing pixel vales, computes the strong filter result for the first pixel values, updates the missing pixel values to be the actual reconstructed values, and computes the strong filter result for the missing pixel locations.

In a second embodiment, the system uses the equations for the strong luma filter described above. For the pixel values not located in the first set of pixel locations, the system derives the pixel values from the first set of pixel locations as described above. The system then computes the strong filter result for both the first and subsequent sets of pixel locations using the derived values. Finally, the system computes a weighted average of the reconstructed pixel values at the subsequent locations and the output of the strong filter at the subsequent locations. In one embodiment, the weight is transmitted from the encoder to the decoder. In an alternative embodiment, the weight is fixed.

If the previously described process results in the decision to de-block a boundary, then the system uses the weak filtering process for chroma as described above. However, when computing the value for Δ, the system does not use the pixel values that correspond to the set of pixels subsequent to the first set. Instead, the system preferably derives the pixel values as in the previously described. By way of example, the value for Δ is then applied to the actual pixel values in the first set and the delta value is applied to the actual pixel values in the second set.

A cascading motion compensation technique enables improved high resolution motion compensation prediction. The low resolution (LR) data of the reference picture(s) are used to perform low resolution motion compensated prediction using low resolution motion data. The missing pixels that comprise the high resolution grid locations are interpolated using a bilinear filter, a bicubic filter, an edge directed filter, or any other suitable type of filter to create interpolated high resolution data. The interpolated high resolution data are used to perform high resolution motion compensated prediction using the low resolution motion data, which is also defined as interpolated high resolution motion compensated prediction. If desired, the interpolated high resolution data may be replaced by non-interpolated high resolution data, which is data derived from the high resolution data in the reference frame(s). The non-interpolated high resolution data is then used to perform high resolution motion compensated prediction using the low resolution motion data, resulting in non-interpolated high resolution motion compensated prediction. The residual may be computed at the encoder as the difference between the full resolution motion compensated prediction and the original image data, and the residual may be processed using any suitable technique. One such processing technique is to compute a forward transform of the residual using a discrete cosine transform, discrete sine transform or any other suitable transform. The forward transform results in transform coefficient values, and the transform coefficient values are then quantized and transmitted to a decoder. The decoder then converts the received quantized coefficients to received transform coefficient values by inverse quantization. The received transform coefficients are then processed with an inverse transform to convert the received transform coefficients to a processed residual. A second technique does not use a forward transform. In this second technique, the residual is quantized to create a quantized residual, and the quantized residual is transmitted to a decoder. The decoder then converts the quantized residual to a processed residual. For any processing technique, the residual for the low resolution motion compensated prediction may be processed separately from the residual for the interpolated high resolution motion compensated prediction. Alternatively, the residual for the low resolution motion compensated prediction may be processed separately from the residual for the non-interpolated high resolution motion compensated prediction. As yet another alternative, the residual for the low resolution motion compensated prediction and interpolated high resolution prediction are not processed separately (processed dependently). Dependent processing of low resolution motion compensated prediction and high resolution motion compensated prediction consists of creating a residual that consists of low resolution compensated prediction at the low resolution grid locations and high resolution prediction data at the high resolution grid locations, where either interpolated high resolution motion compensated prediction or non-interpolated high resolution motion compensated prediction may be used for high resolution motion compensated prediction As yet another alternative, the residual for the low resolution motion compensated prediction and non-interpolated high resolution prediction are not processed separately (processed dependently).

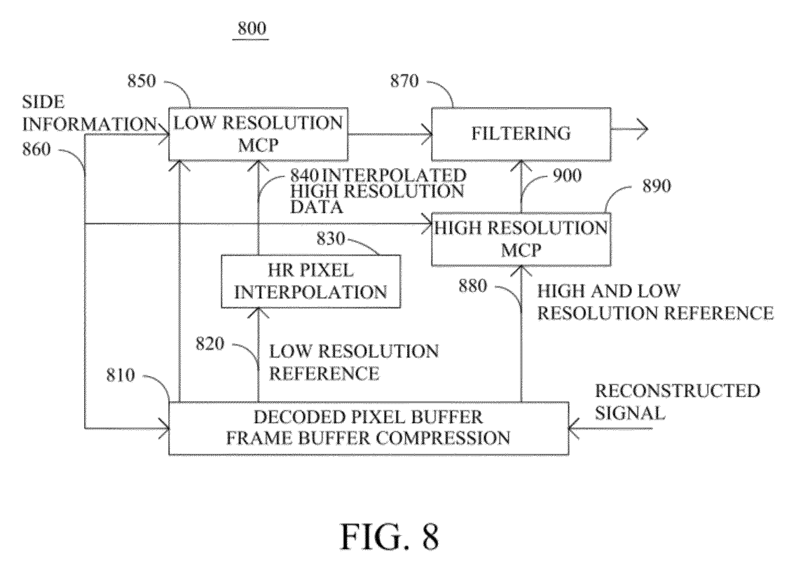

In alternative embodiments, the system may interpolate the high resolution data, creating interpolated high resolution data, using a filter that is signaled in the bit-stream. In another embodiment, the system interpolates the high resolution data using a filter that is identified by an index in the bit-stream. In yet another embodiment, the system does not explicitly interpolate the high resolution data. Instead, during a first pass the system performs the interpolation and motion compensation step simultaneously (see FIG. 8, including the HR pixel interpolation 830 and the low resolution MCP 850 together with explicitly generating the interpolated high resolution data 840). During a second pass, the low resolution and high resolution components of the references are used to construct the high resolution data of current block using the motion compensated prediction as well (see FIG. 8, the high resolution MCP 890).

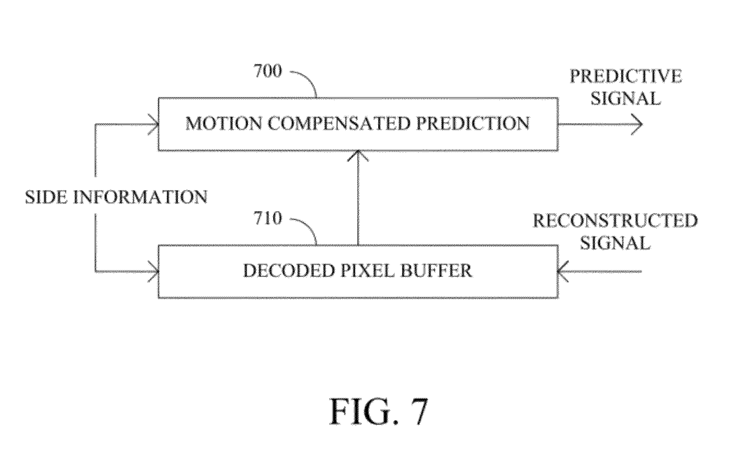

Referring to FIG. 7, the motion compensated prediction 700 receives the prediction from reference picture(s) according to parsed side information, such as for example a motion vector, that may include a reference index to form the predictive signal, and information from the decoded pixel buffer 710. The predictive signal is a signal that includes data that is representative of predictive pixels. Accordingly, the pixel information from the buffer 710 may be provided for the motion compensated prediction 700 to be used together with motion vectors to determine the predictive signal. To enable graceful power reduction, it is preferable to include a cascading motion-compensation technique to allow the low resolution motion compensated prediction for power reduction in the decoder.

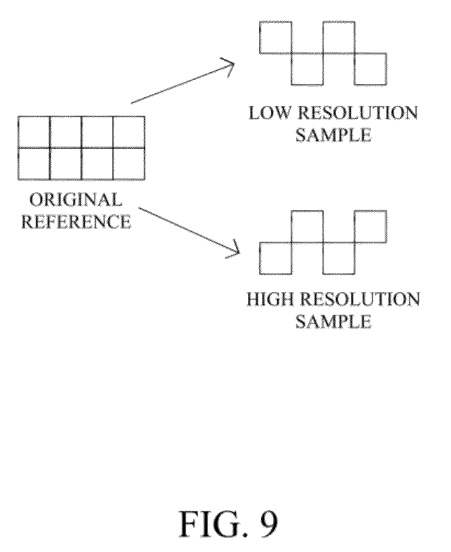

Referring to FIG. 8, the cascading motion compensation 800 for power reduction is illustrated. Initially, the decoded pixel buffer 810 including the reconstructed frame or the reference frame is sampled into low resolution (LR) and high resolution (HR) decomposition, or LR and HR grid locations. The preferred sampling technique for the low resolution and the high resolution decomposition of the image includes a checker-board pattern, as illustrated in FIG. 9.

The low resolution samples, or data, 820 within the decoded pixel buffer 810 are provided to a high resolution pixel interpolation module 830. The high resolution pixel interpolation module 830 interpolates the high resolution grid locations not included within the low resolution samples 820. The interpolation 830 may use any suitable technique, such as bilinear interpolation, bicubic interpolation, or edge based interpolation. The high resolution pixel interpolation module 830 provides an output that includes both the low resolution samples 820 together with the interpolated high resolution samples 830 as high resolution data 840.

A low resolution motion compensated prediction (“MCP”) module 850 receives the high resolution data 840 from the high resolution pixel interpolation module 830 and side information (e.g., motion vectors) 860. The low resolution motion compensated prediction module 850 uses the motion vectors for the low resolution grid locations as a predictor for both the low resolution and the high resolution data. Accordingly, the motion vectors for the low resolution grid locations are used for both the low resolution data and the interpolated high resolution data.

The high resolution motion compensated prediction module 890 uses the low resolution side information 860 to predict the high resolution data for the frame based upon the high and low resolution data. In this manner, the low resolution data and the corresponding high resolution data (those grid locations not already included within the low resolution pixel data) are both used to predict only the corresponding high resolution pixel data, referred to as the high resolution data 900. Accordingly, the system maintains the predicted low resolution data that included the interpolated high resolution data from the low resolution MCP 850. Also, the system predicts the interpolated high resolution data 890 based upon the same low resolution prediction information 860 and the combination of the non-interpolated high resolution data and low resolution data 880.

The additional processing by the high resolution motion compensated prediction module 890 permits improved performance, if desired by the system. The high resolution MCP 890 may perform its prediction in any suitable manner, preferably in the same manner as described with respect to the low resolution MCP 850. In some cases, the system may use the low resolution motion compensated pixels, or low resolution motion compensated prediction, 850 and optionally include the additional complexity of the high resolution motion compensated pixels, or non-interpolated high resolution motion compensated prediction, 890, depending on power usage considerations. It may further be observed that the low resolution motion compensated prediction does not depend on the high resolution motion compensated prediction.

A filtering module 870 may receive the predicted high resolution data 900 from the high resolution motion compensated prediction 890 and replace the interpolated high resolution motion compensated prediction from the low resolution motion compensated module 850. Accordingly, the filtering module 870 may include the low resolution motion compensated prediction and the non-interpolated high resolution, motion compensated prediction. The filtering module 870 may further filter the low resolution data and/or the high resolution data in different manners, as desired, to account for their differences. In this manner, when not enabled the filtering only replaces the pixel data located at the high resolution grid locations and when enabled the filter replaces the data at all high resolution grid locations. Thus, the enabling and no enabling of the filter may be signaled in the bit-stream or other suitable manner. In an alternative embodiment, the filtering module replaces the pixel data located at the high resolution grid locations with values determined from the pixel data located at the high resolution grid locations in the high resolution motion compensated prediction from the low resolution motion compensated module 850 and the pixel data located at the high resolution grid locations in the predicted high resolution data 900 from the high resolution motion compensated prediction 890. The filter module computes the data to replace the pixel data located at the high resolution grid locations as a weighted average of the interpolated high resolution motion compensated prediction from the low resolution motion compensated module 850 and the predicted high resolution data 900 from the high resolution motion compensated pixels, or non-interpolated high resolution motion compensated prediction, 890. In an yet another embodiment, the filter module replaces the pixel data located at the high resolution grid locations with values determined from the predicted high resolution data 900 and the predicted low resolution data from the low resolution motion compensated pixels, or low resolution motion compensated prediction, 890. The filter module computes the data to replace the pixel data located at the high resolution grid location of a weighted average of the predicted high resolution data 900 and pixel data located at nearby low resolution grid locations of the low resolution motion compensated pixels, or low resolution motion compensated prediction, 890. Here, the term nearby low resolution grid locations may be defined as grid locations that are spatially adjacent to a given high resolution grid location. In alternative embodiments, nearby low resolution grid locations may be defined to be within a fixed number of grid locations. For example, a nearby low resolution grid location may be not be separated by more than two grid locations from a given high resolution grid location. Alternatively, a nearby low resolution grid location may not be separated by more than three grid locations from a given high resolution grid location. Other nearby low resolution grid location definitions may be used, if desired.

To further provide added flexibility, the low resolution intra prediction should only require low resolution data from the reconstructed video blocks, or reconstructed data. The estimation of the high resolution data from the available low resolution data should be performed in a manner that requires minimal modifications to the system.

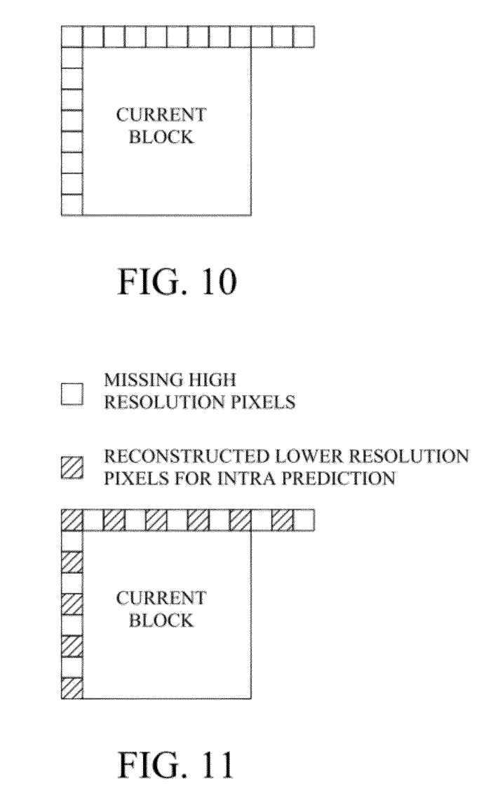

Referring to FIG. 10, a conventional intra prediction may use the reconstructed data (normally performed prior to in-loop deblocking and adaptive loop filtering) from the complete set of upper and left blocks to construct the predictive signal of the current block. The difference between the predictive signal and the original signal is encoded into the bitstream. The reconstructed data used for such prediction are the one line of pixels from above the current block and the one line of pixels to the left of the current block.

Referring to FIG. 11, for low resolution based intra prediction, the system has a more limited selection of available reconstructed data. For example, the reconstructed low resolution pixels, or data, from available upper and left blocks may include every other pixel. In general, the available upper and/or left blocks may include less than all pixels. It is desirable to estimate the “missing” high resolution pixels, or data, in a manner that is transparent to the rest of the system, thus permitting effective estimation without requiring other modifications to the system. Therefore, while the intra prediction may have limited data which results in power savings, the other parts of the decoder and/or encoder will operate in the same manner. To effectively exploit the local content features, one or more of the following techniques may be used to estimate the “missing” high resolution data, or the data located at the high resolution grid locations. The resulting predicted block may include low resolution data and/or high resolution data.

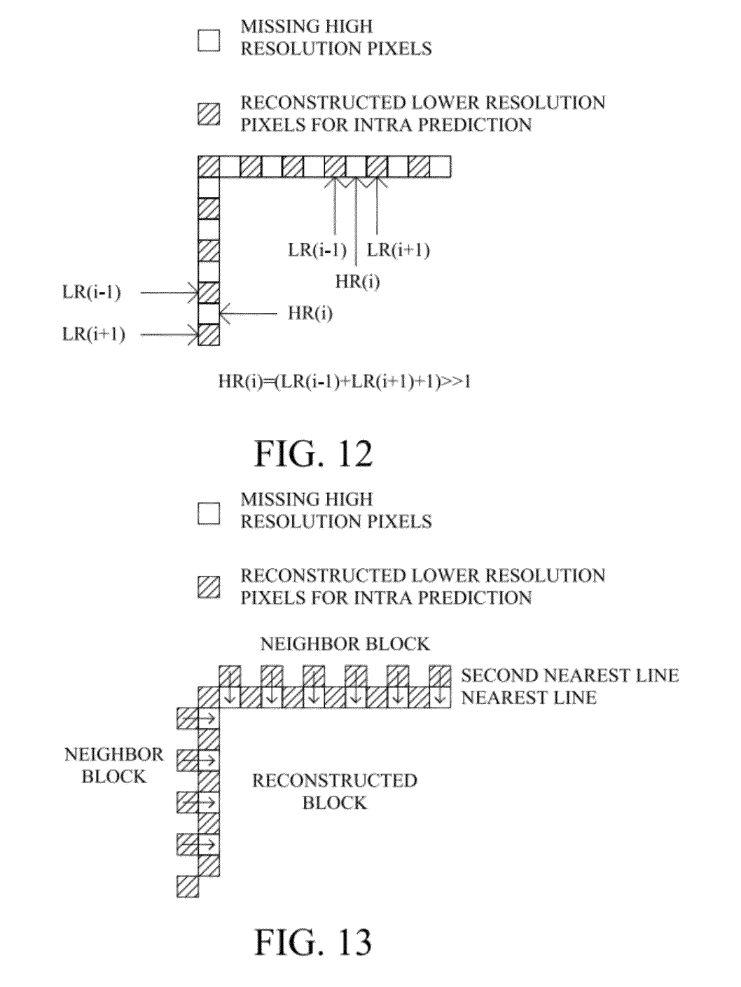

Referring to FIG. 12, one technique to estimate the missing pixels is by using bilinear interpolation. The bilinear interpolation may be achieved by interpolating the high resolution pixel, or data, adjacent available low resolution pixels, or data. For the horizontal high resolution pixel at position i, the position (i−1) and (i+1) are both the low resolution pixels, which are the left and right positions for the horizontal case. Therefore, HR(i)=(LR(i−1)+LR(i+1)+1)>>1. For the vertical high resolution pixel at position i, the position (i−1) and (i+1) are both the low resolution pixels, which are the upper and lower positions for the vertical case. Therefore, HR(i)=(LR(i−1)+LR(i+1)+1)>>1.

Referring to FIG. 13, another technique to estimate the missing pixels is by using direct pixel copy. The direct pixel copy may be used to construct the missing high resolution pixels. Instead of using the pixels from the nearest line of reconstructed blocks, the system preferably uses the two nearest lines and/or two nearest columns from the neighbor blocks. In the case of the checker-board pattern, the system can use the low resolution pixels from the second nearest line and/or column to estimate the high resolution pixels at the nearest line and/or column.

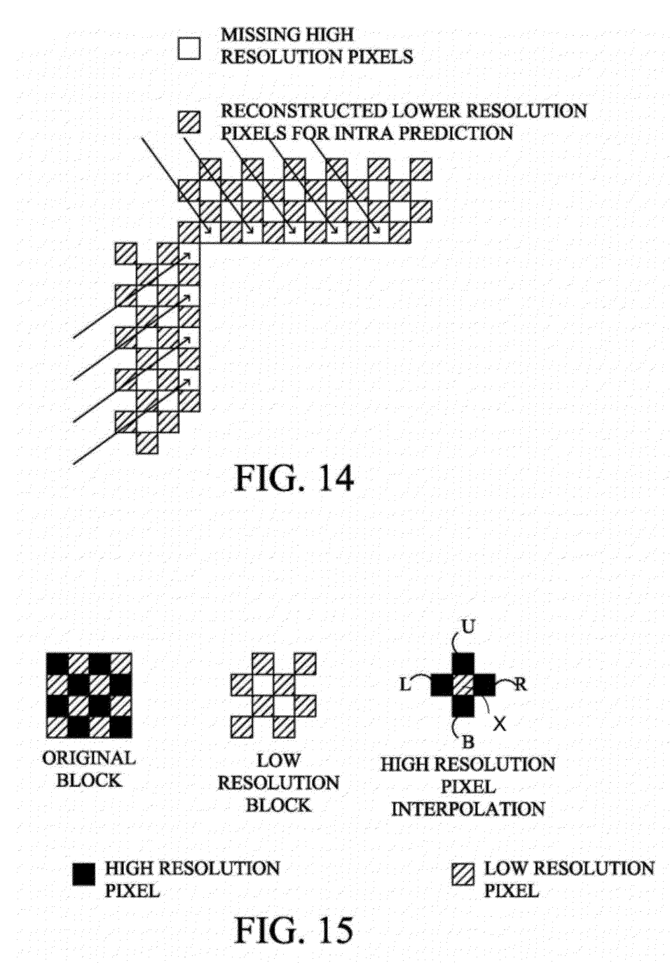

Referring to FIG. 14, another technique to estimate the missing pixels is by using directional pixel estimation. Directional pixel estimation can take advantage of directional pixel correlations in the reconstructed block. The prediction modes (direction prediction type) of upper and left blocks may also be used as side information to instruct the high resolution pixel estimation. For example, the high resolution pixels can be a linear combination of the available low resolution pixels along the prediction direction.

In another embodiment, the system may not need to use an explicit copy operation to determine the values for the “high resolution” pixel locations, or high resolution grid locations, in FIG. 14. Instead, the system may make use a weighted combination of pixel values within the neighborhood of each “high resolution” pixel. In an embodiment, this neighborhood may consist of the value to the left, right and above the current pixel location. In another embodiment, this neighborhood may consist of the value above, below and to the left of the current pixel location. Other neighborhood definitions may likewise be used, as desired.

In another embodiment, the system may derive the prediction direction by analyzing the values at the pixel locations within the neighborhood for the current pixel location. In an embodiment, this analysis may consist of computing the local correlation within the neighborhood. In another embodiment, this analysis may consist of estimating the edge direction within the neighborhood. In another embodiment, this analysis may consist of first determining if an edge appears within the neighborhood. If an edge appears, a first interpolation direction is chosen that may depend on analysis of the direction of said edge. If an edge does not appear, a second interpolation technique may be selected. The second interpolation technique is not a direction technique. In a first embodiment, the bi-linear operator is used. In a second embodiment, a Gaussian filter is used. In a third embodiment, a Lanczos filter is used.

In another embodiment, the system may signal the prediction direction explicitly in a bit-stream. The direction may be calculated at the encoder and transmitted to a decoder.

In another embodiment, the system may derive the prediction direction from information explicitly transmitted in the bit-stream. As an example, the prediction direction may be derived from the intra-prediction mode used for the intra-prediction process.

In another embodiment, the system may derive the prediction direction at the decoder and then transmit a correction to the prediction in a bit-stream. In a one embodiment, the system may derive the prediction direction from analysis of the values within the neighborhood of a current pixel. In another embodiment, the system may derive the prediction direction from information explicitly transmitted in the bit-stream. In yet another embodiment, the system may derive the prediction direction from a combination of pixel value analysis and information transmitted explicitly in the bit-stream.

Referring to FIG. 15, an original block may be decomposed into a low resolution (LR) and a high resolution (HR) set of samples, or grid locations. The full resolution signal is the composite of both low resolution and the high resolution components. The hatched pixels shown in FIG. 15 are the low resolution pixels, while the solid pixels (for purposes of clarity) are the high resolution pixels, or high resolution data.

By removing the high resolution pixels, the system may save 50% memory access so as to reduce the memory power consumption dramatically. The removed high resolution pixel is referred to as “X”, the left nearby pixel is referred to as “L”, the right nearby pixel is referred to as “R”, the upper nearby pixel is referred to as “U”, and the lower nearby pixel is referred to as “B”. The 4-th order linear combination of adjacent low resolution pixels may be used to estimate the missing high resolution pixels as shown. This may be characterized as,

X=a1*L+a2*U +a3*R+a4*B

where a1, a2, a3 and a4 are the interpolate filter coefficients.

Following this prediction, the system may code the residual difference between the prediction and target signal. In one embodiment, the system may use the edge preserving interpolation process at all pixel locations. In another embodiment, an encoder signals the use of the edge preserving interpolation process. This signaling may be at any resolution such as at a sequence, frame, slice, coding unit, macro-block, block or pixel resolution. In yet another embodiment, the edge preserving interpolation technique may be combined with other interpolation methods using a weighted averaging approach. In a further embodiment, the weights in the weighted average (above) may be controlled by image analysis and/or information in the bit-stream.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A video decoder that decodes video from a bit-stream comprising:
(a) a low resolution predictor that predicts pixel values based upon both a low resolution reference image and an interpolated high resolution reference image, where said low resolution reference image and said interpolated high resolution reference image are not co-sited, using low resolution motion data;
(b) a high resolution predictor that predicts pixel values based upon both a non-interpolated high resolution reference image and said low resolution reference image, where said non-interpolated high resolution reference image and said low resolution reference image are not co-sited, using said low resolution motion data.

2. The video decoder of claim 1 wherein said high resolution predictor replaces said predicted pixel values based upon said interpolated high resolution reference image at said positions different from said low resolution reference image with said predicted non-interpolated high resolution reference image.

3. The video decoder of claim 1 wherein a filter used for said interpolated high resolution reference image is signaled in a bit-stream.

4. The video decoder of claim 1 wherein a filter used for said interpolated high resolution reference image is identified by an index in a bit-stream.

5. The video decoder of claim 1 wherein said interpolated high resolution reference image is determined based upon said low resolution reference image.

6. The video decoder of claim 1 wherein said interpolated high resolution reference image and said low resolution reference image are provided to said low resolution predictor from a high resolution pixel interpolation module.

7. The video decoder of claim 1 wherein a filtering module replaces said predicted interpolated high resolution image with said predicted non-interpolated high resolution image.

8. The video decoder of claim 1 wherein a filtering module provides a modified predicted high resolution image based upon at least two of said predicted low resolution image from said low resolution predictor, said predicted interpolated high resolution image from said low resolution predictor, said predicted low resolution image from said high resolution predictor, and said predicted non-interpolated high resolution image.

9. The video decoder of claim 8 wherein said predicted low resolution image from said low resolution predictor, said predicted low resolution image from said high resolution predictor are different.
